(19) United States
(12) Patent Application Publication
(10) Pub. No.: US 2005/0001709 A1
(43) Pub. Date: Jan. 6, 2005

(54) Inductive device and methods for assembling same

(76) Inventors: Martin R. Pais, North Barrington, IL (US); James R. Booth, Cary, IL (US); David J. Moore, Saint John, IN (US); Detlef W. Schmidt, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 10/613,155

(22) Filed: Jul. 3, 2003

(51) Int. Cl. H01F 27/28

(52) U.S. Cl. 336/229

(57) ABSTRACT

An inductive device (200) that includes a core (210) configured so as to be a closed loop and at least one coil (220) around the core, and methods for assembly. The coil is formed from a material having a cross-section with an aspect ratio of a first dimension to a second adjacent dimension, with the first dimension being longer than the second dimension, wherein the coil is positioned around the core such that the first dimension is essentially normal to the core. In one embodiment the core includes a removable core section to enable assembly of the inductive device by slidably placing the coil onto the core through an opening formed in the core by removing the core section. In another embodiment, the coil is rotated to cause it to wind around the core.

### FIELD OF THE INVENTION

The present invention relates generally to inductive devices, and specifically to inductive devices comprising a coil formed from a material having a cross-section with an aspect ratio of a first dimension to a second adjacent dimension, wherein the first dimension is longer than the second dimension.

### BACKGROUND OF THE INVENTION

Inductive devices, such as inductors and transformers, are used in many electronic devices. These inductive devices typically include a single core having one or more windings or coils. In many instances the core is configured so as to be a closed loop such as, for instance, a toroidal shaped core. Moreover, typically, the core is wound with a wire having a circular cross-sectional area in order to facilitate efficient automated winding. However, this requirement results in an inefficient use of core area. An example of such an automated method for winding a wire with a circular cross-section onto a toroidal core is found in U.S. Pat. No. 5,331,729 to Moorehead (hereinafter referred to as “Moorehead”).

A shortcoming of the method disclosed in Moorehead for winding a coil around a core is that the method is designed solely for use in winding wire having a circular cross-section. This is because if the wire cross-section is non-circular, the wire will not correctly form around the core but will undesirably twist or collapse. Moreover, as stated above, limiting the wire cross-section in this manner results in an inefficient use of core area. FIG. 1 illustrates a prior art inductive device 100 having a coil 110 formed with a wire having a circular cross-section 115 around a toroidal core 120 such as, for instance, an inductive device assembled in accordance with the methods taught in Moorehead.

The inductance value of an inductive device is directly related to the square of the number of turns of the winding of the inductive device, i.e., L=N²I, where: L is the inductance value of the inductive device; N is the number of turns; and I is the current through the inductive device. When attempting to achieve a given inductance value for an inductive device that may be used, for instance, in an electronic device, typically the current (I) is constrained to a maximum amount by the power requirements of the electronic device. Therefore, it is generally more feasible to control the inductance value as a function of the number of turns (N).

One way of increasing the number of turns on a core is by increasing the size of the core to accommodate additional windings. However, this may not be feasible if there are limitations on the maximum size of the electronic device. Thus, when the core size cannot be enlarged, it is known in the art to fit more turns onto a given toroidal core by using multiple coils that are coaxial with each other and possibly of a smaller gauge to allow for an equivalent cross-sectional area for a given turn of wire.

A shortcoming of this inductive device design is that it detrimentally affects the performance of the inductive device. This is especially noted in the performance of high frequency switching power supply circuits where electro-magnetic interference (“EMI”) noise can be of great concern. In the range of 1-30 MHz, the switching noise produced by the circuit cannot be filtered out by the inductive device due to a parasitic capacitance generated in the inductive device. During turn-on switching of a power transistor in the power supply circuit, it is possible for the discharge current of this parasitic capacitance to exceed 1 Amp. Using an inductive device with a low parasitic capacitance can therefore significantly reduce noise and EMI filter cost. A single layer winding with fewer turns is the most effective way to achieve a low parasitic capacitance. This is especially true when an iron powder core is used because it has a high gauss capability that requires fewer turns for a given inductance than that required by other materials.

Another method known in the art to increase the number of turns for a given core area is overlapping turns from a prior winding layer. Typically, in this design, the winding direction at the end of the first layer is reversed rather than continuing the winding over the start of the first layer. This winding overlap, likewise, detrimentally affects the electrical performance of the inductive device. For instance, magnetic field cancellation is adversely affected causing more EMI noise to be generated. The winding overlap also causes a lower self-resonance of the inductive device, which can affect the high frequency performance characteristics of the inductive device. Often in this case an additional smaller inductive device is provided in series with the primary inductive device to minimize the effects of this self-resonance. This extra inductive device creates an additional cost to the end product and requires more component space.

Thus, there exists a need for an inductive device and methods for assembling the inductive device that: enables the use of the smallest core possible based on the power requirements of the electronic device; optimizes the number of turns on a single layer; and minimizes parasitic capacitance by eliminating, in most cases, the need to overlap windings in the inductive device.

### BRIEF DESCRIPTION OF THE FIGURES

A preferred embodiment of the invention is now described, by way of example only, with reference to the accompanying figures in which:

FIG. 1 illustrates a prior art inductive device;

FIG. 2 illustrates an inductive device in accordance with an embodiment of the present invention;

FIG. 3a illustrates a toroidal core with a circular cross-section in accordance with an embodiment of the present invention;

FIG. 3b illustrates a toroidal core with a triangular cross-section in accordance with an embodiment of the present invention;

FIG. 3c illustrates a toroidal core with a rectangular cross-section in accordance with an embodiment of the present invention;

FIG. 4a illustrates a helical coil formed from a wire having a trapezoidal cross-section in accordance with an embodiment of the present invention;

FIG. 4b illustrates a helical coil formed from a wire having a triangular cross-section in accordance with an embodiment of the present invention;

FIG. 4c illustrates a helical coil formed from a wire having a rectangular cross-section in accordance with an embodiment of the present invention;

FIG. 4d illustrates a helical coil formed from a wire having an irregular cross-section in accordance with an embodiment of the present invention;

FIG. 5 illustrates a flow diagram of an assembly process for an inductive device in accordance with an embodiment of the present invention;

FIG. 6 illustrates a core that includes a removable core section that is configured so as to be a wedge, in accordance with an embodiment of the present invention;

FIG. 7 illustrates a helical coil being slid onto a core through an opening formed by a removable core section in accordance with an embodiment of the present invention;

FIG. 8 illustrates a helical coil being coaxed-indexed onto a core using a separate fixture in accordance with an embodiment of the present invention;

FIG. 9 illustrates an inductive device after being assembled in accordance with the process illustrated in the flow diagram of FIG. 5;

FIG. 10 illustrates a flow diagram of an assembly process for an inductive device in accordance with another embodiment of the present invention;

FIG. 11 illustrates a cylindrical helical coil of wire of rectangular cross section in accordance with the assembly process illustrated in the flow diagram of FIG. 10;

FIG. 12 illustrates a coil being started onto a core in accordance with the assembly process illustrated in the flow diagram of FIG. 10;

FIG. 13 illustrates a coil being wound onto a core in accordance with the assembly process illustrated in the flow diagram of FIG. 10;

FIG. 14 illustrates a completed toroid assembled in accordance with the assembly process illustrated in the flow diagram of FIG. 10;

FIG. 15 illustrates the optimization of the number of turns for a completed toroid assembled in accordance with the assembly process illustrated in the flow diagram of FIG. 10; and

FIG. 16 illustrates the detailed dimensions of the coil cross-sectional shapes illustrated in FIG. 4.

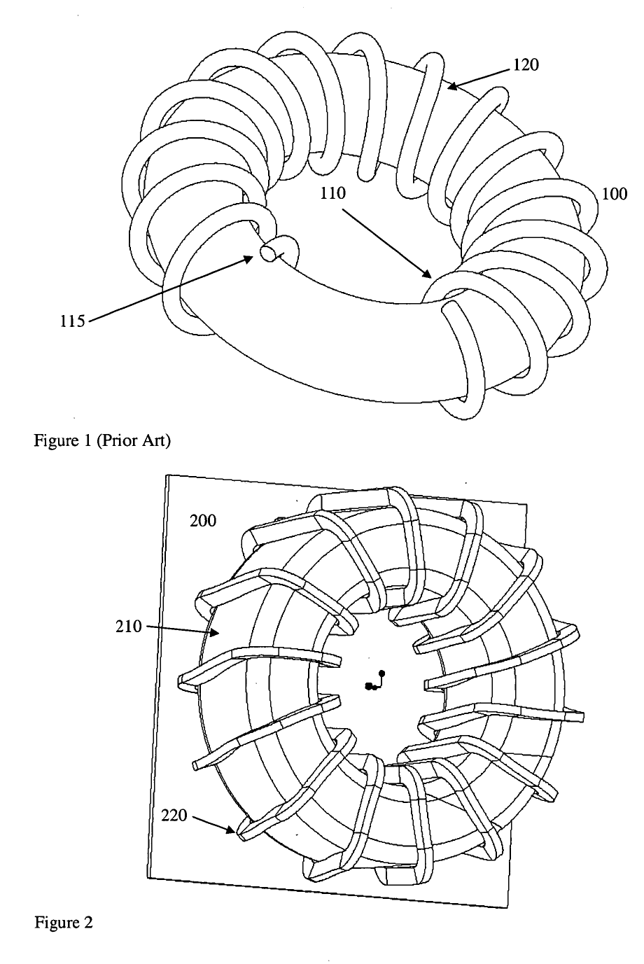

### DETAILED DESCRIPTION OF THE PREFERRED EMBODIMENT

While this invention is susceptible of embodiments in many different forms, there are shown in the figures and will herein be described in detail specific embodiments, with the understanding that the present disclosure is to be considered as an example of the principles of the invention and not intended to limit the invention to the specific embodiments shown and described. Further, the terms and words used herein are not to be considered limiting, but rather merely descriptive. It will also be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate corresponding elements.

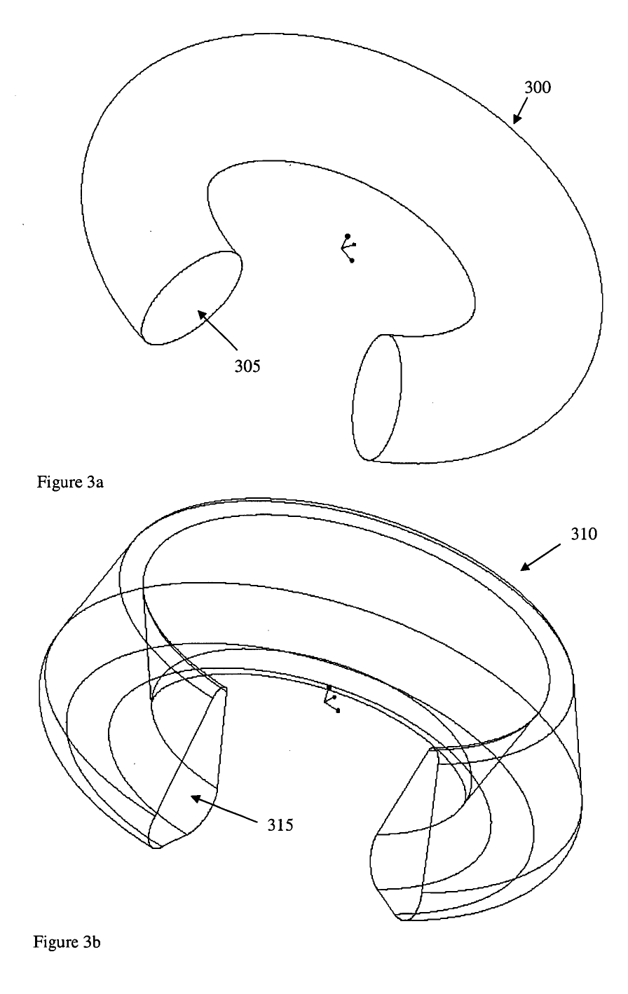

FIG. 2 illustrates an inductive device 200 in accordance with an embodiment of the present invention. Device 200 comprises a core 210 and a coil 220 that is assembled around core 210. In one embodiment, the advantages of inductive device 200 may find particular use in the manufacture of inductor components that are widely used in a variety of electronic circuits such as base station power supplies and base radio cabinet power supplies. It is appreciated, however, that the instant advantages of the present invention are equally applicable to other types of components wherein such coil and core assemblies are employed, such as transformer components. While the illustrated embodiment includes a single continuous coil 220 with only two ends (not illustrated), in alternate embodiments it is contemplated that more than one coil could be employed while achieving the benefits of the instant invention. For instance, a primary winding and a secondary winding could be employed, and with the appropriate selection of the number of turns of the primary and secondary windings in such an embodiment, a step-up or step-down transformer is provided. It is understood that further components neither described nor depicted herein may be employed as needed or as desired to provide an acceptable inductor or transformer for particular applications.

Core 210 is fabricated from a known material to meet specified performance objectives of the inductive device 200. Core 210 is further configured so as to be a closed loop. The closed loop may be accomplished in several ways. For instance, core 210 may be fabricated as a single contiguous core using a single material, as illustrated in FIG. 2. Core 210 may also be fabricated having a “removable” core section, wherein the main body of the core and the core section is fabricated using the same material. In another embodiment, the main body of the core is fabricated using a first type of material, and the core section is formed from a second material that is dissimilar to the first material. The second material may be air, thus causing the core to effectively have a gap and the closed loop to be implemented with air. One example of a device wherein the second material may be air is a Flyback transformer.

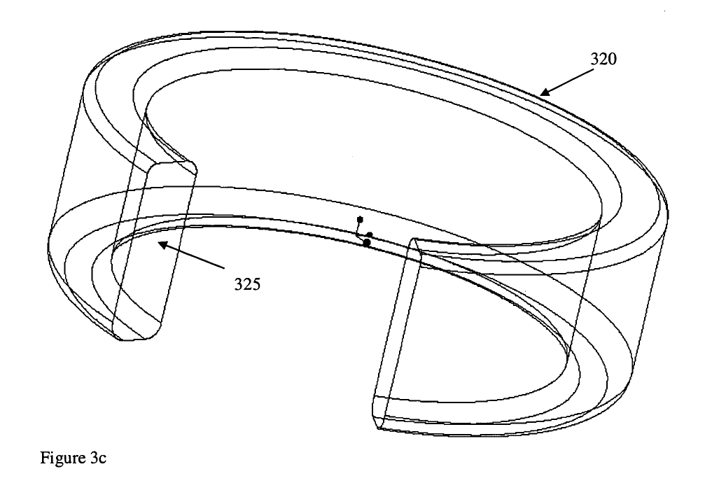

The core section may be cut along any section of the core. Furthermore, the core 210 may be configured into a toroidal shape, or a shape generated by a plane closed curve rotated about a line that lies in the same plane as the curve but does not intersect it. Typically the toriodal core is in the shape of a ring as illustrated in FIG. 2, but may take the shape of any type of polygon with rounded corners or with angled corners depending on the application for inductive device 200. Finally, the cross-section of core 210 may be formed having various shapes, as illustrated in FIGS. 3a-3c. FIG. 3a illustrates a toroidal core 300 with a circular cross-section 305 in accordance with an embodiment of the present invention. FIG. 3b illustrates a toroidal core 310 with a triangular cross-section 315 in accordance with an embodiment of the present invention, and FIG. 3c illustrates a toroidal core 320 with a rectangular cross-section 325 in accordance with an embodiment of the present invention.

Those of ordinary skill in the art will realize that the core cross-section may also have other shapes not illustrated herein. It is further understood that although FIGS. 3a-3c illustrate the core with a gap, this is not meant to limit the present invention in any way but to more easily demonstrate the shape of the core's cross-section.

Coil 220 is fabricated from a known material and includes a number of turns to achieve a desired effect such as, for instance, a desired inductance value for a selected end use application of inductive device 200. In an illustrative embodiment, coil 220 is formed from a conductive wire according to known techniques. As those in the art will appreciate, an inductance value of inductive device 200, in part, depends upon wire type and a number of turns of wire in the coil. As such, inductance ratings of inductive device 200 may be varied considerably for different applications. Furthermore, in accordance with known methods and techniques, wire used to form coil 220 may be coated with enamel coatings and the like to improve structural and functional aspects of coil 220.

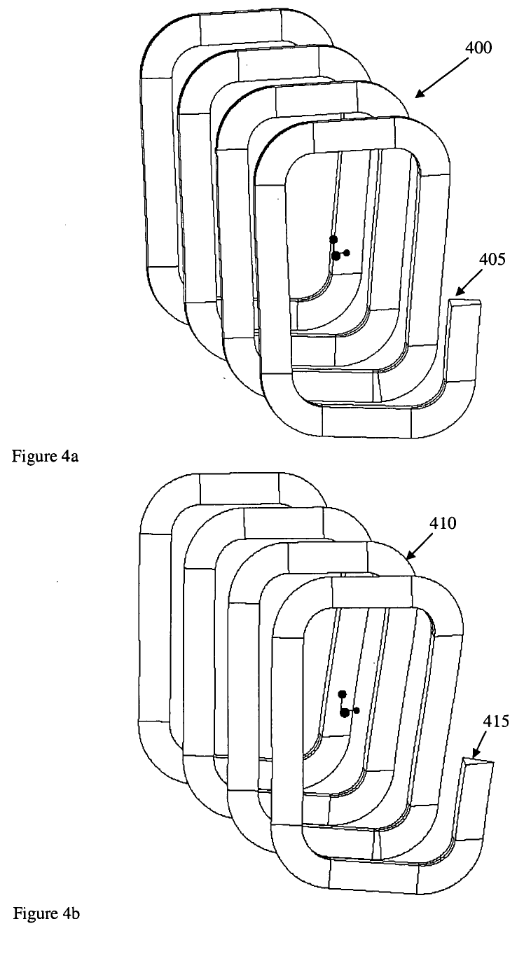

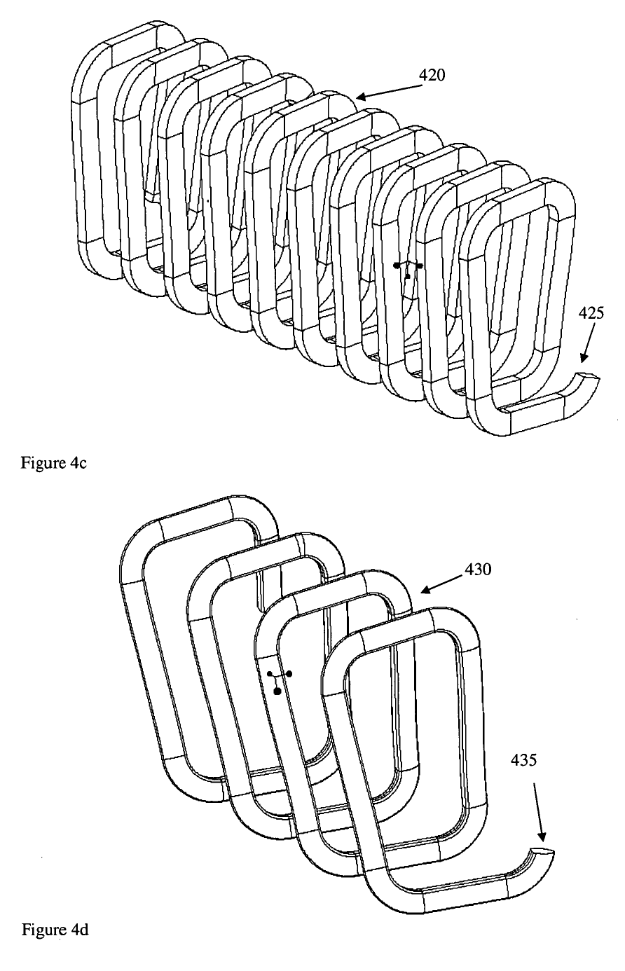

In an exemplary embodiment of the present invention, the cross-section of the wire used to form coil 220 has at least one aspect ratio of a first (or major) dimension to a second (or minor) dimension, wherein the first dimension is longer than the second dimension. Moreover, the major dimension is preferably a maximum characteristic dimension based on the axis of symmetry of the wire's cross-section. FIGS. 4a-4d illustrate various cross-sectional shapes of the wire used to form coil 220, and FIG. 16 illustrates the detailed dimensions of the coil cross-sectional shapes illustrated in FIG. 4. FIG. 4a illustrates a helical coil 400 formed from a wire having a trapezoidal cross-section 405 in accordance with an embodiment of the present invention. FIG. 4b illustrates a helical coil 410 formed from a wire having a triangular cross-section 415 in accordance with an embodiment of the present invention. FIG. 4c illustrates a helical coil 420 formed from a wire having a rectangular cross-section 425 in accordance with an embodiment of the present invention, and FIG. 4d illustrates a helical coil 430 formed from a wire having an irregular shaped cross-section 435 in accordance with an embodiment of the present invention. Those of ordinary skill in the art will realize that the wire cross-section may also have other shapes not illustrated herein such as, for instance, a hexagon.

FIG. 16 illustrates dimensions B and C for each of cross-sections 405 (trapezoid), 415 (triangle), 425 (rectangle), and 435 (irregular shaped). Preferably, dimension B is the maximum characteristic dimension based on the axis of symmetry of each cross-section, and as will be discussed later in detail, is preferably positioned such that it is essentially normal to the core.

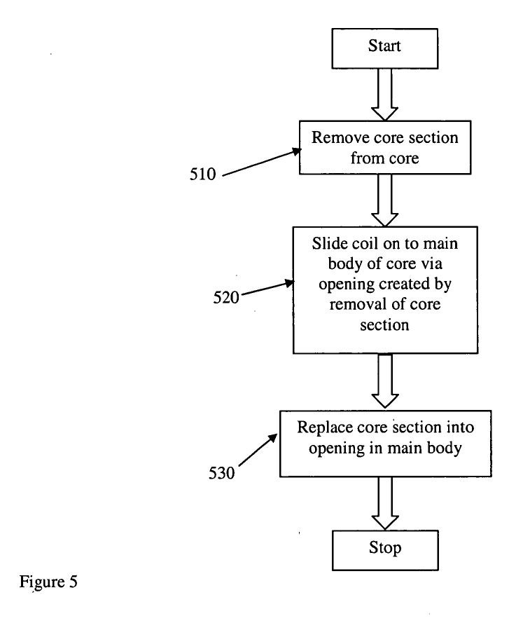

The coil helix is illustrated in FIGS. 4a-4c as having a rectangular shape, but the helix may have any other shape such as, for instance, a circular shape or cross-section. The shape of the helical coil cross-section is generally determined by the amount of core cross-section area desired and the level of ease desired for manufacturing the inductive device. In one embodiment, the cross-section of the core and the cross-section of the coil helix are the same and are circular. Finally, the coil 220 may be formed around a device that is separate from the inductive device to create its helical pattern, using methods known in the art. The coil may then later be assembled around the core using an assembly process such as the ones illustrated in the flow diagrams of FIGS. 5 and 10.

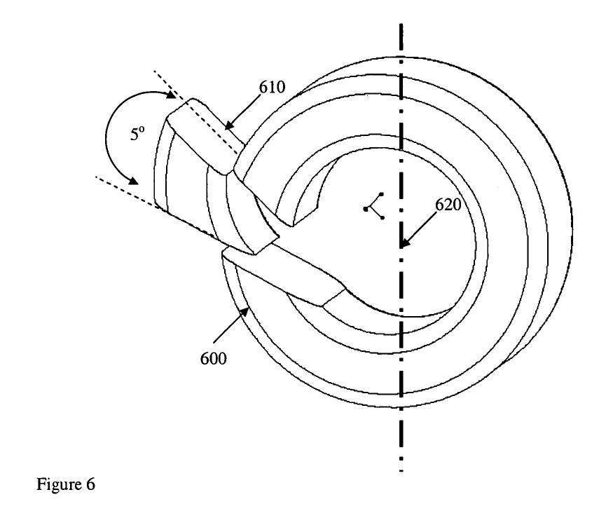

FIG. 5 illustrates a flow diagram of an assembly process for an inductive device in accordance with an embodiment of the present invention. In this exemplary embodiment, an inductive device is assembled from a coil and a core, wherein the core is fabricated with a removable core section in accordance with the above description. Preferably, the core section is configured so as to be a wedge as illustrated in FIG. 6, wherein the core section can remain securably attached to the main core body without the use of an adhesive. However, in an alternative embodiment, the core section may be secured into place using an adhesive. FIG. 6 illustrates a toroidal core 600 that includes a removable core section 610 that is configured so as to be a wedge, in accordance with an embodiment of the present invention. Preferably, the wedge is cut along any section of core 600 other than the plane of symmetry 620 through the core axis, and in an exemplary embodiment is cut at a five degree angle so that the two sides of the cut are not parallel. Such a design enables the wedge to lock itself into the main body of the core.

As can be seen, core section 610 has a rectangular cross-section. Moreover, the coil is fabricated into a helix, typically having a length somewhat smaller than the circumference of the core. In general balancing the length of the helical coil against the circumference of the core may optimize the size and performance of the inductive device in a particular application, and is useful in maximizing the number of turns for the inductive device.

Returning to the process illustrated in FIG. 5, in the first step (510), the core section is removed. The coil is then slidably placed around the main core body (520) via the gap or opening formed by removing the core section. If there are multiple coils, each coil should be slidably placed on the core in accordance with the above described step 520. For instance, a common mode choke may be assembled using the process illustrated in FIG. 5 by slidably placing two coils around the core, wherein the coils are positioned end-to-end with a space between the ends.

As described above, the coil is formed from, preferably, a wire having an aspect ratio of a first dimension to a second adjacent dimension, wherein the first dimension is longer than the second dimension (i.e., an aspect ratio of greater then one), and the first dimension, i.e., dimension B (FIG. 16), is the maximum characteristic dimension based on the axis of symmetry of each cross-section. Thus, in step 520, the coil is slid onto the core such that the coil is positioned around the core with dimension B being essentially normal to the core. Then the widest of the dimensions that are adjacent to dimension B, i.e., dimension C, is positioned adjacent to the core. This is because, geometrically, as we traverse toward the center of a circular structure, the local circumference reduces, hence, the edge must reduce for a fully packed embodiment.

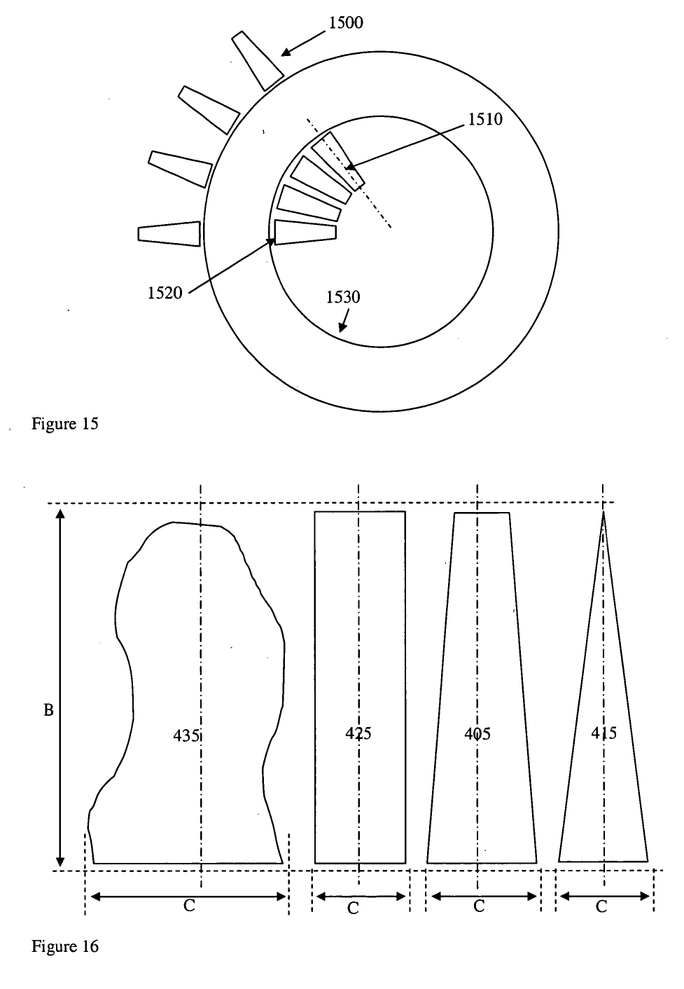

For instance, with respect to FIG. 15 wherein the wire cross-section 1500 is a trapezoid, dimension 1510 is the maximum characteristic dimension based on the axis of symmetry of the trapezoid, and it is positioned essentially normal to the core 1530. Moreover, the widest of the dimensions adjacent to dimension 1510, i.e., dimension 1520, is positioned adjacent to core 1530.

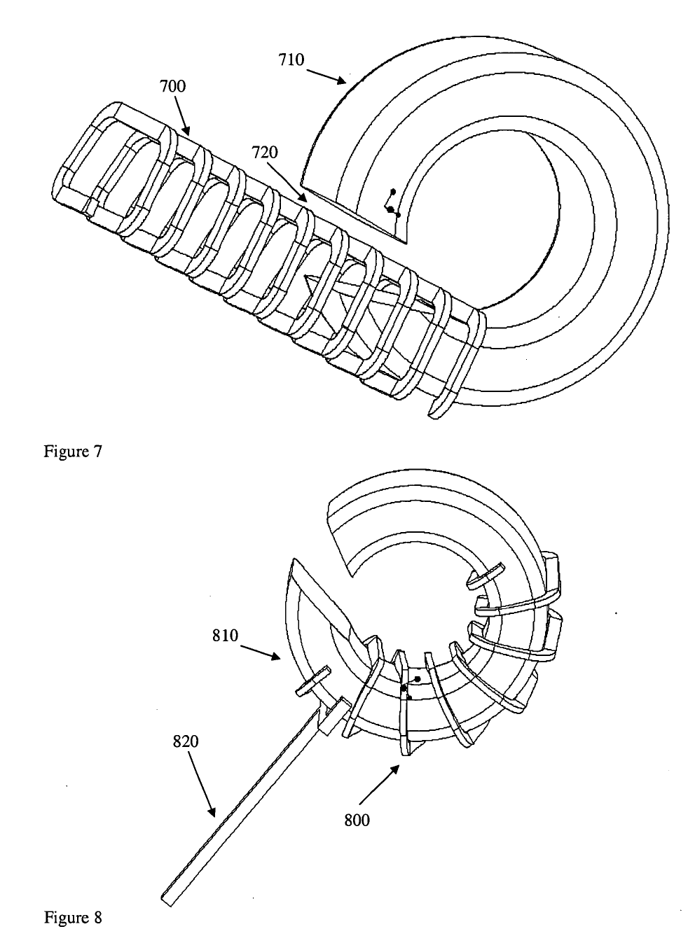

FIG. 7 illustrates a helical coil 700 being slid onto a core 710 through an opening 720 formed by removing the core section in accordance with an embodiment of the present invention. In an exemplary embodiment, the helical shape of coil 700 is the same as the cross-sectional shape of the core, which in this example is rectangular. Having the helical shape the same as the core's cross-sectional shape may ease the process of sliding the coil onto the core and also provides for the best electromagnetic coupling between the coil and the core.

In another embodiment, the coil may be coaxed onto the core using a known separate fixture which could be driven manually or in an automated fashion. FIG. 8 illustrates a helical coil 800 being coaxed onto a core 810 using an exemplary separate “indexing finger” 820 in accordance with an embodiment of the present invention. The illustrative “indexing finger” 820 prods the coil forward, and could take many other forms, including but not limited to, for example, an indexing screw or indexing gear. Generally, it is desired that the wire fit around the core as tightly as possible. The use of an “indexing finger” as illustrated in FIG. 8 facilitates the sliding of the coil around the core in a manner that is faster and easier than is generally possible without its use. This is turn facilitates mass manufacturing of inductive devices according to the present invention.

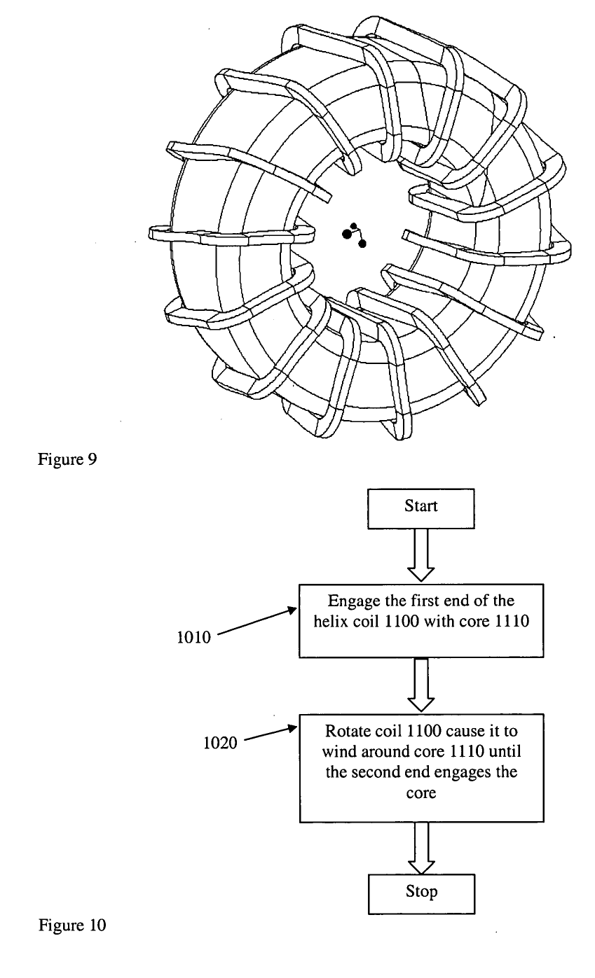

Returning to the process illustrated in FIG. 5, once the coil is slid onto the core, the core section is replaced into the main body of the core (530), as illustrated in FIG. 9, so that a magnetic path generated in the assembled inductive device is not interrupted. The core section may then be optionally secured into place using any suitable adhesive such as, for instance, in a high vibration application where the core section-core assembly is not deemed sufficiently robust.

For the embodiment of the invention where the core section comprises air, the assembly process illustrated in FIG. 5 may be simplified to include only step 520 of slidably placing the coil around the core via the gap in the core. According to this embodiment, there is no need to remove (510) the core section and then replace (530) it back into the core.

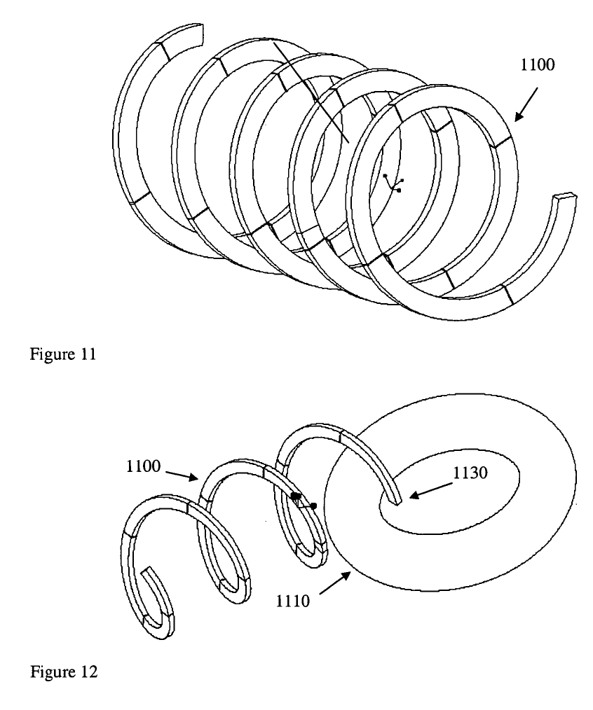

FIG. 10 illustrates a flow diagram of an assembly process for an inductive device in accordance with another embodiment of the present invention. This assembly process may be implemented, for instance, using an automated process or a manual process. In an exemplary embodiment, an inductive device is assembled from a helical coil with a first and a second end and a core configured so as to be a closed loop. The core may or may not have a gap. Preferably, the helical coil has a circular shape as illustrated in FIG. 11. Coil 1100 may be formed on a device that is separate from the inductive device, to create its helical pattern, using methods known in the art such as, for instance, Scott Corporation's Helical Winding Technology (HWT™) as described in the company's website, www.schottcorp.com.

In one embodiment of the present invention, coil 1100 may first be formed and then subsequently assembled around the core using an assembly process such as the one illustrated in the flow diagram of FIG. 10. In an alternative embodiment, coil 1100 may be formed and contemporaneously assembled around the core using an assembly process such as the one illustrated in the flow diagram of FIG. 10 such as, for instance, in an in-line automated assembly process.

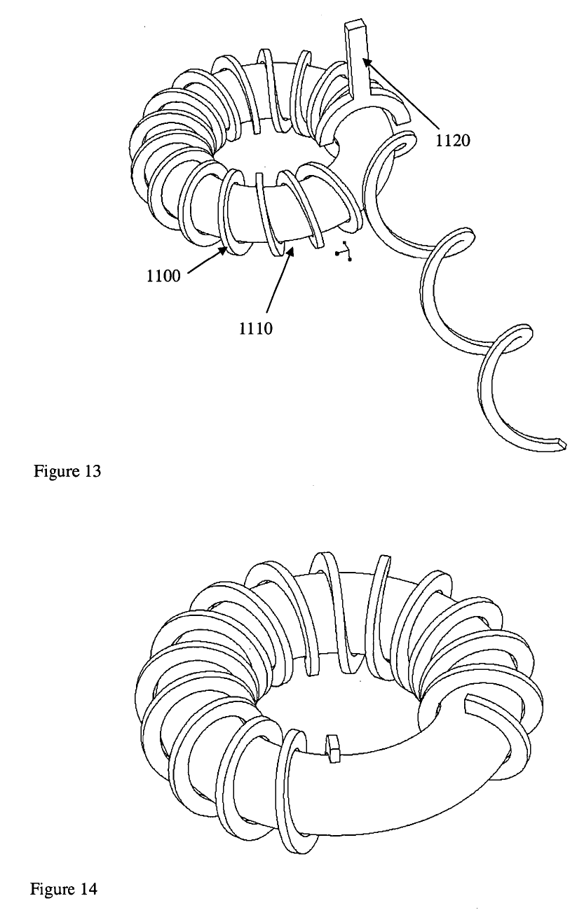

Referring again to FIG. 10, at step 1010 a first end of the helical coil is engaged with the core. FIG. 12 illustrates the leading edge 1130 of the helical coil 1100 being fed and started around the core of the toroid 1110. Next, at step 1020, the coil is rotated to cause it to wind around the core and is rotated until the second end of the coil engages the core. The helical nature of the coil lends itself to automatically wind itself around the core and feed itself forward like a screw. To assist the coil in more smoothly following the core, a paddle like traversing mechanism 1120 can optionally be implemented, as in FIG. 13. The traversing mechanism could also take the form of a screw or gear or other shape conducive to automatically helping the coil wrap around the core. FIG. 14 illustrates the completed inductive device assembled in accordance with the flow diagram illustrated in FIG. 10.

Preferably, the coil 1100 is fabricated using a pitch (defined as the center-to-center spacing between two consecutive turns of the coil) which is approximately the same size or greater than a predetermined cross-section diameter of the core 1110. This will facilitate the process by reducing any unnecessary interference or rubbing. Moreover, the coil 1100 is fabricated into a helix, preferably, having a compressed length that is less than or substantially the same as, the internal circumference of the core 1110. Finally, where the steps of FIG. 10 are performed as part of an automated process, the second end of the coil is preferably cut subsequent to step 1010 of engaging the first end with the core.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

1. An inductive device comprising:
a core configured so as to be a closed loop; and
at least one coil around said core, said coil formed from a first material having a first cross-section with an aspect ratio of a first dimension to a second adjacent dimension, said first dimension being longer than said second dimension, wherein said coil is positioned around said core such that said first dimension is essentially normal to said core.

2. The inductive device of claim 1, wherein said core is formed from a second material and includes a core section formed from a third material.

3. The inductive device of claim 2, wherein said second and third material are the same.

4. The inductive device of claim 2, wherein said third material is dissimilar to said second material.

5. The inductive device of claim 4, wherein said third material is air.

6. The inductive device of claim 2, wherein said core section is configured so as to be a wedge.

7. The inductive device of claim 2, wherein said coil is formed and then slidably placed around said core through an opening formed in said core by removing said core section.

8. The inductive device of claim 7, wherein said coil is formed around a second device, that is separate from said inductive device, and removed from said second device before being slidably placed around said core.

9. The inductive device of claim 1, wherein said core is configured into a toroidal shape.

10. The inductive device of claim 1, wherein said core is configured into a polygon.

11. The inductive device of claim 10, wherein said polygon has rounded corners.

12. The inductive device of claim 1, wherein said inductive device is an inductor.

13. The inductive device of claim 1, wherein said inductive device is a transformer.

14. The inductive device of claim 1, wherein said core has a second cross-section and said coil is a helix having a third cross-section.

15. The inductive device of claim 14, wherein said second and third cross-sections are the same.

16. The inductive device of claim 14, wherein said second and third cross-sections are circular.

17. The inductive device of claim 1, wherein said first dimension is a maximum characteristic dimension based on the axis of symmetry of said first cross-section.

18. A method for assembling an inductive device comprising a coil formed from a material having a cross-section with an aspect ratio of a first dimension to a second adjacent dimension, said first dimension being longer than said second dimension, and a core configured so as to be a closed loop, said core further including a removable core section, said method comprising the steps of:
removing said core section from said core;
slidably placing said coil around said core, through an opening in said core formed by removing said core section, such that said first dimension is positioned essentially normal to said core; and
replacing said core section into said core.

19. The method of claim 18 further comprising securing said core section in place using an adhesive.

20. The method of claim 18, wherein said coil is slidably placed around said core using a separate fixture.

21. A method for assembling an inductive device comprising a coil formed from a material having a cross-section with an aspect ratio of a first dimension to a second adjacent dimension, said first dimension being longer than said second dimension, and a core configured so as to be a closed loop, said core further including a core section that is a gap, said method including the step of slidably placing said coil around said core, through an opening in said core formed by said gap, such that said first dimension is positioned essentially normal to said core.

22. A method for assembling an inductive device comprising a helical coil having a first and a second end, and a core configured so as to be a closed loop, said method comprising the steps of:
engaging the first end of said coil with said core; and
rotating said coil for causing said coil to wind around said core, wherein said coil is rotated until said second end engages said core.

23. The method of claim 22, wherein the steps of said method are performed manually.

24. The method of claim 22, wherein the steps of said method are performed as part of an automated process.

25. The method of claim 24, wherein said second end is formed after said first end is engaged with said core.

26. The method of claim 22, further comprising the step of guiding said coil around said core using a separate device.

27. The method of claim 22, wherein said coil is formed from a material having a cross-section with an aspect ratio of a first dimension to a second adjacent dimension, said first dimension being longer than said second dimension and said coil is wound around said core such that said first dimension is essentially normal to said core.

28. The method of claim 22, wherein said core is configured into a toroidal shape with a predetermined cross-section diameter and said helical coil has a pitch that is at least as long as said diameter.

29. The method of claim 22, wherein said core is configured into a toroidal shape with a predetermined inner circumference and a predetermined outer circumference, and said coil has a compressed length from said first end to said second end that is substantially the same as said inner circumference.
